(19) United States
(12) Patent Application Publication
(10) Pub. No.: US 2026/0343328 A1
(43) Pub. Date: Oct. 29, 2026

(54) GROUP HANDOVER AND PCI COLLISION PREVENTION IN MOBILE IAB SCENARIO

(71) Applicant: APPLE INC., Cupertino, CA (US)

(72) Inventors: Peng Cheng, Beijing (CN); Fangli Xu, Beijing (CN); Ralf Rossbach, Munich (DE); Naveen Kumar R Palle Venkata, San Diego, CA (US); Alexander Sirotkin, Hod Hasharon (IL); Yuqin Chen, Beijing (CN); Haijing Hu, Los Gatos, CA (US)

(21) Appl. No.: 18/997,352

(22) PCT Filed: Aug. 8, 2022
(86) PCT No.: PCT/CN2022/110881

§ 371 Date: Jan. 21, 2025

(51) Int. Cl. H04W 36/00

(52) U.S. Cl. CPC H04W 36/0009

(57) ABSTRACT

The present disclosure relates to methods and devices for group handover and Physical Cell Identifier (PCI) collision prevention in mobile Integrated Access and Backhaul (IAB) scenario. According to the present disclosure, a User Equipment (UE) may receive, from a source IAB donor, a reconfiguration message associated with group handover. This reconfiguration message may indicate an identifier of a UE group including one or more UEs served by a migration IAB node and multiple security key change rules, wherein said UE belongs to the UE group, and wherein the migration IAB node performs an inter-donor switch from the source IAB donor to a target IAB donor. The UE may further receive, from the migration IAB node, a triggering message for group handover. This triggering message indicating said identifier of the UE group and a determined security key change rule corresponding to the UE group, wherein the determined security key change rule is included in the multiple security key change rules. In response to receiving the triggering message, the UE may perform a group handover from the source IAB donor to the target IAB donor, based on the determined security key change rule corresponding to the UE group. Additional or alternatively, a UE may receive, from a source IAB donor, a reconfiguration message associated with PCI collision prevention. This reconfiguration message associated with PCI collision prevention may indicate one of (i) and (ii): (i) a measurement of PCIs of one or more neighbor cells for the UE and a timer to indicate how long the UE performs the measurement for the PCIs of the one or more neighbor cells; and (ii) a detection of PCI collision between a serving cell for the UE and one or more neighbor cells for the UE. Each cell may include an IAB node, and the reconfiguration message associated with PCI collision prevention may be used for avoiding PCI collisions when the UE performs a handover from the source IAB donor to a target IAB donor.

### TECHNICAL FIELD

This application relates generally to wireless communication systems, including devices, systems and methods for group handover and Physical Cell Identifier (PCI) collision prevention in a mobile Integrated Access and Backhaul (IAB) scenario.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments are presented herein of devices, systems, and methods for several critical issues in a scenario including a mobile Integrated Access and Backhaul (IAB) node. The present disclosure is mainly directed to user equipment (UE) group handover and PCI collision prevention in such a scenario.

According to the techniques described herein, a UE may be configured to receive, from a source IAB donor, a reconfiguration message associated with group handover. This reconfiguration message may indicate an identifier of a UE group including one or more UEs served by a migration IAB node and multiple security key change rules, wherein said UE belongs to the UE group, and wherein the migration IAB node performs an inter-donor switch from the source IAB donor to a target IAB donor and serves said UE. The UE may be further configured to receive, from the migration IAB node, a triggering message for group handover. This triggering message indicating said identifier of the UE group and a determined security key change rule corresponding to the UE group, wherein the determined security key change rule is included in the multiple security key change rules. In response to receiving the triggering message, the UE may be configured to perform a group handover from the source IAB donor to the target IAB donor, based on the determined security key change rule corresponding to the UE group.

Additionally or alternatively, according to the techniques described herein, a UE may be configured to receive, from a source IAB donor, a reconfiguration message associated with PCI collision prevention. This reconfiguration message associated with PCI collision prevention may indicate one of (i) and (ii): (i) a measurement of PCIs of one or more neighbor cells for the UE and a timer to indicate how long the UE performs the measurement for the PCIs of the one or more neighbor cells; and (ii) a detection of PCI collision between a serving cell for the UE and one or more neighbor cells for the UE. In such case, each cell may include an IAB node, and the reconfiguration message associated with PCI collision prevention may be used for avoiding PCI collisions when the UE performs a handover from the source IAB donor to a target IAB donor.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example IAB network, according to embodiments disclosed herein.

FIG. 4 illustrates an example IAB network and its components, according to embodiments disclosed herein.

FIG. 5A and FIG. 5B are flowchart diagrams illustrating an example method for supporting group handover in mobile IAB node scenario, according to embodiments disclosed herein.

FIG. 6A and FIG. 6B are flowchart diagrams illustrating an example method for supporting PCI collision prevention in mobile IAB node scenario, according to embodiments disclosed herein.

FIG. 7 illustrates an example signaling diagram between a UE and network-side devices, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

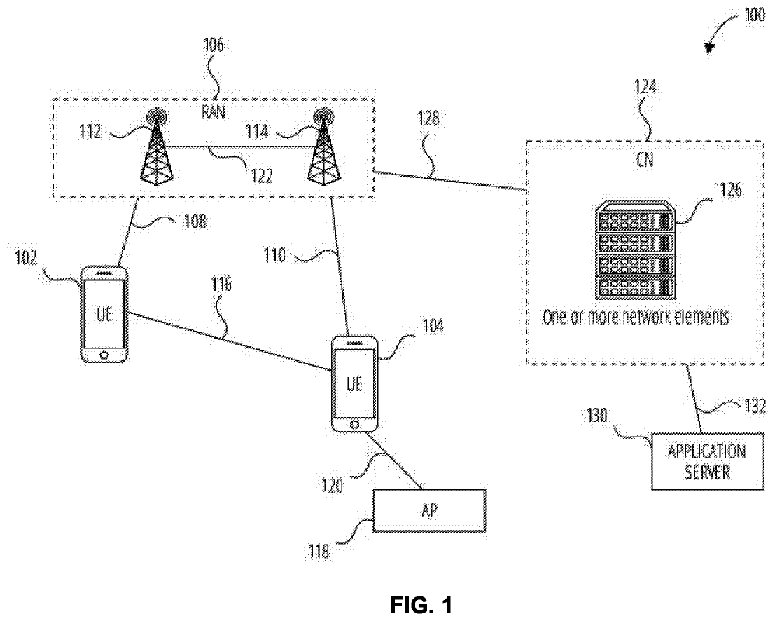

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

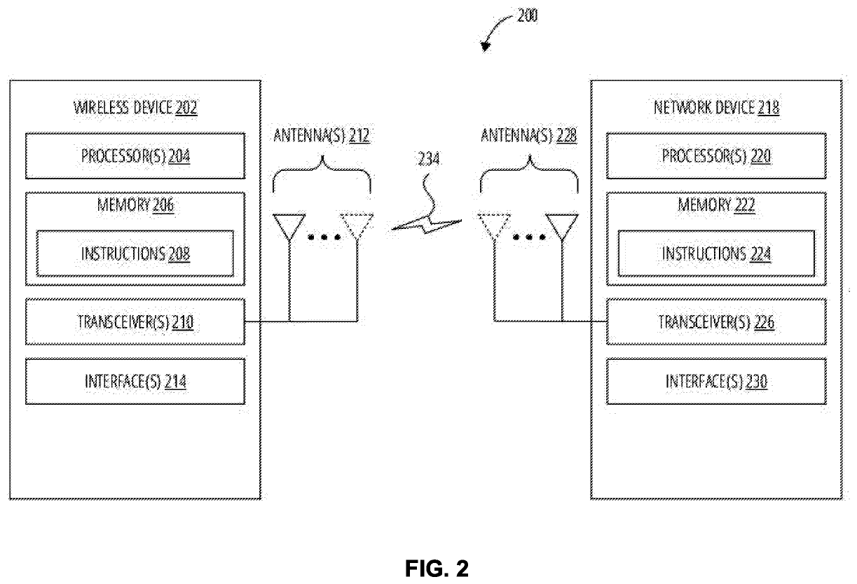

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### ACRONYMS

Various acronyms are used throughout the present disclosure. Definitions of the most prominently used acronyms that may appear throughout the present disclosure are provided below:
3GPP: Third Generation Partnership Project
5GS: 5G System
5GC/5GCN: 5G Core Network
ACK: Acknowledgement
BAP: Backhaul Adaptation Protocol
BS: Base Station
CE: Control Element
CU: Central Unit
DRB: Data Radio Bearer
DU: Distributed Unit
IAB: Integrated Access and Backhaul
ID: Identifier
IE: Information Element
LTE: Long Term Evolution
MAC: Medium Access Control
MT: Mobile Terminal
NR: New Radio
NCC: Next Chain Count
NCGI: NR Cell Global Identifier
OAM: Operation, Administration and Maintenance
PCI: Physical Cell Identifier
PDU: Protocol Data Unit
QoS: Quality of Service
RACH: Random Access Channel
RF: Radio Frequency
RLC: Radio Link Control
RNTI: Radio Network Temporary Identity
C-RNTI: Cell-Radio Network Temporary Identity
RRC: Radio Resource Control
RRM: Radio Resource Management
SA: Standalone
SIB: System Information Block
UE: User Equipment

### Overview of IAB Network

One of challenges in network deployments of 5G NR system (and even 6G system) would be the fact that the cell coverage might be small. An NR cell is likely to use a higher frequency than a legacy cell (such as an LTE cell). It becomes difficult to deploy a large number of network devices (such as gNBs) to provide a good and wide coverage with small cell radius. In such case, an IAB network naturally becomes a good solution.

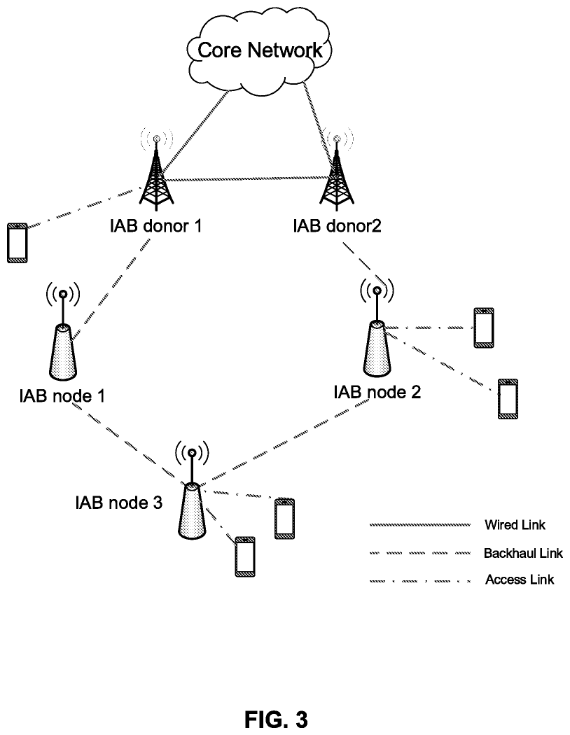

FIG. 3 illustrates an example IAB network, according to embodiments disclosed herein. As shown in FIG. 3, an IAB network may include one or more IAB donors (such as IAB donor 1 and IAB donor 2) and one or more IAB nodes (such as IAB node 1, IAB node 2 and IAB node 3). Both of the IAB donor and the IAB node may be collectively referred to as “IAB device” throughout the present disclosure, which belongs to network devices 218. As an example, the IAB donor may perform functions to manage and control the IAB nodes. The IAB node may comprise L2 relay node, etc. Generally, multiple IAB donors may be connected via wired links, and they may be configured to communicate with a network (e.g., a cellular service provider's core network, a telecommunications network such as a public switched telephone network (PSTN), and/or Internet, etc.) via a wired medium (e.g., cable, fiber, etc.). An IAB node may connect to its parent IAB node (also called upstream IAB node, which is closer to the IAB donor) or its child IAB node (also called downstream IAB node, which is farther to the IAB donor) or an IAB donor via wireless backhaul links. Each IAB donor or IAB node may serve and connect to one or more wireless devices (such as UE) via wireless access links, thus facilitating communications between multiple wireless devices and/or communications between wireless devices and the network.

It should be understood that an IAB device (referred to an IAB donor or an IAB node herein) may operate in accordance with one or more wireless communication technologies to provide continuous or nearly continuous Radio signal coverage. The coverage area of an IAB device is generally referred to as a cell. Cells of different IAB devices may have different sizes. For example, an IAB donor may be in a macro cell, while an IAB node may be in a small cell.

It should be appreciated that the IAB network in FIG. 3 is merely exemplary and not intended to be limiting. The IAB network may include more or less devices in practice. In addition, the IAB network according to the present disclosure may be applicable to FR1 and FR2, and the IAB node may support in-band and out-of-band backhauling.

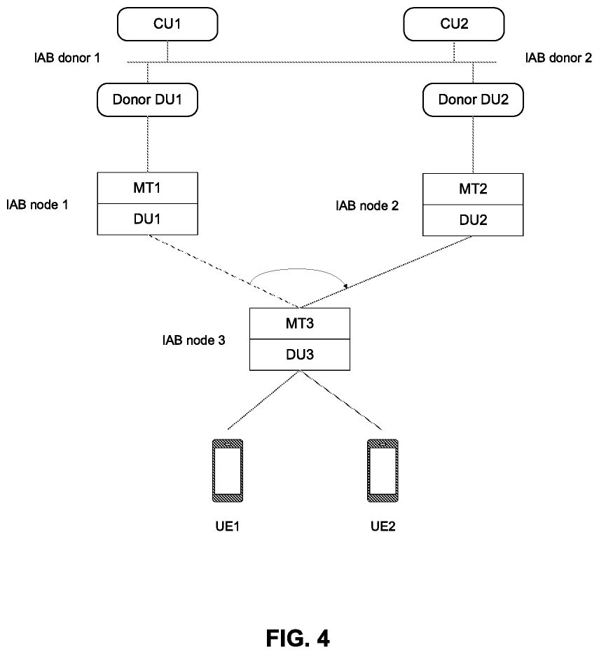

In an existing IAB network, an IAB node is normally assumed to be static. However, new scenarios for IAB network including mobile IAB node(s) are attracting more and more attentions from both of industry and academic field. According to aspects of the present disclosure, all or part of IAB nodes may be movable. For example, IAB node 3 and all or part of its served UEs may be located on a vehicle (e.g., a car, a bus, an airplane, a ship, a train, a high-speed rail, etc.), thus they are movable. In order to enable IAB node mobility, a migration procedure for the entire mobile IAB node (also referred to as “migration IAB node” herein) is required to be considered. Related issues will be introduced and discussed in connection with FIG. 4 hereinafter.

### Migration in IAB Network

FIG. 4 illustrates an example IAB network and its components associated with a migration IAB node.

As shown in FIG. 4, an IAB donor (e.g., IAB donor 1 or IAB donor 2) may include a Central Unit (CU) and a Distributed Units (DU) (sometimes the IAB donor may include multiple DUs). The CU of the IAB donor may provide control for the IAB network, and it may perform higher layer (such as Radio Resource Control (RRC) layer) functions. The DU of the IAB donor may perform scheduling for communication resources for downstream IAB nodes or served UEs for that IAB donor, and it may perform lower layer (such as Radio Link Control (RLC) layer or Medium Access Control (MAC) layer) functions. It should be noticed that in the present disclosure, the CUs of different IAB donors are different. That is, the CU of IAB donor 1 (CU1) is different from the CU of IAB donor 2 (CU2), and they could be connected via a wired link.

An IAB node (e.g., IAB node 1, IAB node 2, or IAB node 3) may include a Mobile Terminal (MT) and a Distributed Unit (DU). The MT and the DU of one IAB node may be logically separated. The MT of the IAB node may operate as a scheduled node by a parent IAB node of that IAB node or an IAB donor, which functions similar to a UE. The DU of the IAB node may schedule a child IAB node and served UEs of that IAB node.

### Inter-Donor Partial Migration

In existing IAB networks that do not consider IAB mobility, a migration procedure of a portion of an IAB node (e.g., the MT of the IAB node) may happen when there is a heavy load on the IAB donor that controls that IAB node. This migration procedure is referred to as “Partial Migration” (or more specifically, “Inter-Donor Partial Migration”) herein. Currently, Inter-Donor Partial Migration is only supported for Standalone (SA)-mode.

In Partial Migration, the MT of an IAB node may migrate to a different parent node underneath another IAB donor CU, while the collocated DU of the same IAB node and its downstream IAB nodes may still retain F1 connectivity to initial IAB donor CU. For example, assuming that IAB donor 1 is the source IAB donor and IAB donor 2 is the target IAB donor, during the Inter-Donor Partial Migration for IAB node 3, MT3 performs an inter-donor switch from the CU of IAB donor (CU1) to the CU of IAB donor 2 (CU2) (as mentioned above, CU1 is different from CU2), while DU3 and its served UEs (e.g., UE1 and UE2) do not change. After Inter-Donor Partial Migration, the F1 traffic of DU3 (and its served UEs) is routed via Backhaul Adaptation Protocol (BAP) layer to which the MT3 has migrated, but finally the F1 traffic will be routed to CU1. In other words, the DU of IAB node 3 (DU3) and its served one or more UEs are still controlled by the CU of source IAB donor (CU1) after Inter-Donor Partial Migration, thus there are no handover operations for DU3 and its served one or more UEs in such case.

### Inter-Donor Full Migration

According to embodiments of the present disclosure, an IAB network involving IAB mobility is considered, where one or more IAB nodes and their connected UEs may be movable. For simplicity of illustration, we assume that a mobile IAB node does not have child IAB nodes and only serves UEs, and it could be referred to as a boundary IAB node in the present disclosure. The migration procedure of the mobile IAB node may involve the migration of the entire IAB node, including the migration of both of its MT and DU. This migration procedure is referred to as “Full Migration” (or more specifically, “Inter-Donor Full Migration”) herein.

In Full Migration, the MT of an IAB node and the DU of the same IAB node may perform inter-donor switch from the source IAB donor to the target IAB donor. For example, assuming that IAB donor 1 is the source IAB donor and IAB donor 2 is the target IAB donor, during the Inter-Donor Full Migration for mobile IAB node 3 (also called migration IAB node 3), both of MT3 and DU3 perform an inter-donor switch from the CU of IAB donor (CU1) to the CU of IAB donor 2 (CU2) (as mentioned above, CU1 is different from CU2). After Inter-Donor Full Migration, DU3 is controlled by CU2. Since the DU of IAB node 3 (DU3) may serve a group of UEs (e.g., UE1 and UE2), this group of UEs are required to perform handover from IAB donor 1 to IAB donor 2 after Inter-Donor Full Migration. In such case, two critical issues should be considered and discussed:

### UE Group Handover

According to the legacy handover procedure, the CU of the source IAB donor needs to send multiple UE dedicated handover commands to all UEs in a UE group served by the migration IAB node, which is likely to cause huge signaling overhead.
Correspondingly, all UEs in the UE group need to perform Random Access Channel (RACH) to the target cell upon receiving the handover command, which is likely to cause RACH collision.
PCI Collision Prevention
As a migration IAB node moves, the PCI of the cell associated with this IAB node (and more particularly, the DU of this IAB node), is likely to collide with any of PCIs of one or more neighbor cells, since static PCI mapping via Operation, Administration and Maintenance (OAM)/CU may not work in such case.

In order to better solve the above two issues regarding mobile IAB scenario, two methods are proposed respectively in the present disclosure. It should be noticed that the two methods may be performed independently, or may be combined together, which will be described in detail hereinafter.

### Method for UE Group Handover

Due to mobility of a migration IAB node and group mobility of UEs served by the migration IAB node, a method for UE group handover is proposed in the present disclosure. The method may be implemented between a UE and a network system which includes at least a source IAB donor, a target IAB donor and a migration IAB node.

In order to avoid RACH collision for a group of UEs, a reconfiguration message associated with group handover may be used to configure change rules of security keys for the group of UEs. After that, a triggering message for group handover may be used to trigger this group of UEs to execute group handover from the source IAB donor to the target IAB donor, after the migration IAB node performs Inter-Donor Full-Migration.

### UE Side

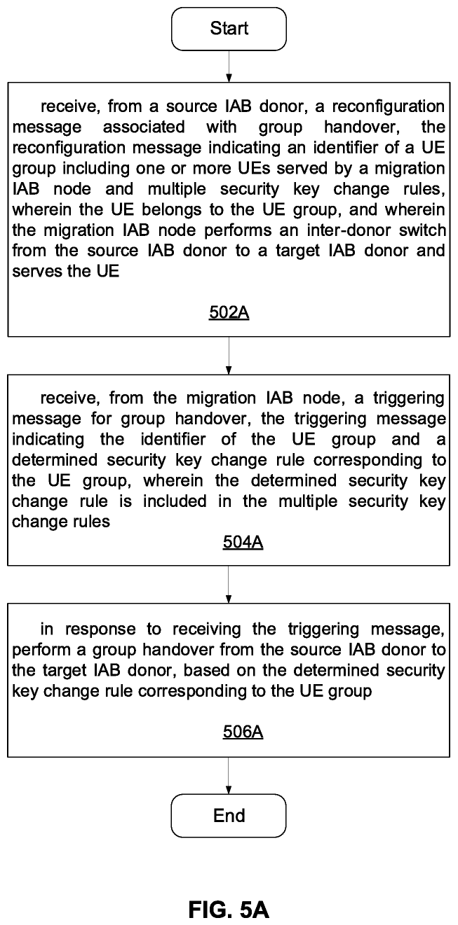

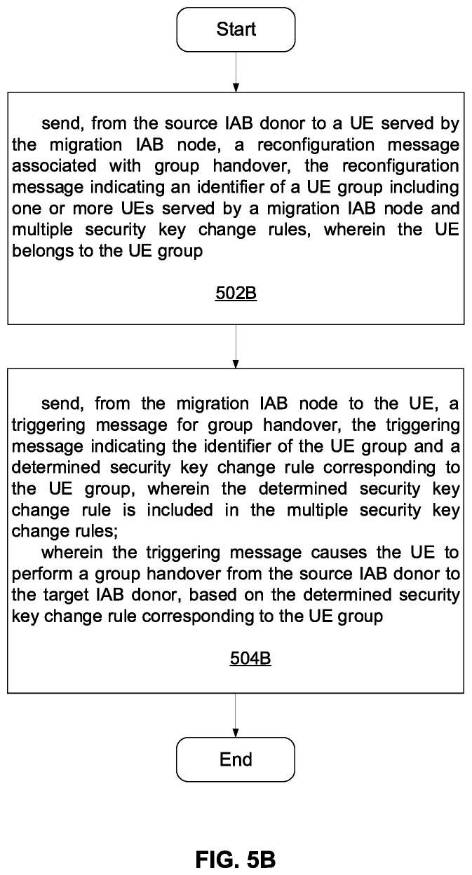

FIG. 5A illustrates a flowchart diagram for an example method at UE side for supporting group handover in mobile IAB node scenario. Aspects of the method of FIG. 5A may be implemented by a wireless device such as a UE 102 or 104 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 5A may operate as follows.

At 502A, a UE may receive from a source IAB donor, a reconfiguration message associated with group handover. The reconfiguration message may indicate an identifier of a UE group including one or more UEs served by a migration IAB node and multiple security key change rules, wherein the UE belongs to the UE group, and wherein the migration IAB node performs an inter-donor switch from the source IAB donor to a target IAB donor and serves the UE.

At 504A, the UE may receive, from the migration IAB node, a triggering message for group handover. The triggering message may indicate the above-mentioned identifier of the UE group and a determined security key change rule corresponding to the UE group, wherein the determined security key change rule may be included in the multiple security key change rules.

At 506A, in response to receiving the triggering message, the UE may perform a group handover from the source IAB donor to the target IAB donor, based on the determined security key change rule corresponding to the UE group.

It should be understood that since the UE is still served by the same migration IAB node (and more specifically, the DU of the same migration IAB node), thus their channel quality does not change, and radio resources are not required to be reconfigured. Therefore, only security key (which is related to handover to the target IAB donor) is required to be changed. In addition, other configurations for the UE in the target cell, e.g., higher layer configurations such as Quality of Service (QoS) flow to Data Radio Bearer (DRB) mapping, may be reconfigured after group handover.

### Network Side

Corresponding to FIG. 5A, FIG. 5B illustrates a flowchart diagram for an example method at network side for supporting group handover in mobile IAB node scenario. Aspects of the method of FIG. 5B may be implemented by a network system including network devices such as IAB devices (e.g., a source IAB donor, a target IAB donor, and a migration IAB node which performs inter-donor switch from the source IAB donor to the target IAB donor) in various of the Figures herein, and/or more generally in conjunction with any of the computer circuitry, systems, devices, elements, or components shown in the above Figures, among others, as desired. For example, processor(s) (and/or other hardware(s)) of such devices may be configured to cause the devices to perform any combination of the illustrated method elements and/or other method elements. As shown, the method of FIG. 5B may operate as follows.

At 502B, the source IAB donor may send, to a UE served by the migration IAB node, a reconfiguration message associated with group handover. The reconfiguration message may indicate an identifier of a UE group including one or more UEs served by a migration IAB node and multiple security key change rules, wherein the UE belongs to the UE group.

At 504B, the migration IAB node may send, to the UE, a triggering message for group handover. The triggering message may indicate the identifier of the UE group and a determined security key change rule corresponding to the UE group, wherein the determined security key change rule may be included in the multiple security key change rules. In such case, the triggering message may cause the UE to perform a group handover from the source IAB donor to the target IAB donor, based on the determined security key change rule corresponding to the UE group.

It should be noted that the reconfiguration message associated with group handover may be transmitted and received via RRC layer, and its specific format depends on the signaling transmission layer of the triggering message for group handover. For example, this triggering message may be transmitted and received via Downlink Control Information (DCI) in Layer 1 (L1), or via Media Access Control (MAC) Control Element (CE) in Layer 2 (L2).

Embodiments contemplated herein include an apparatus comprising means to perform one or more elements of the method for group handover according to the present disclosure. This apparatus may be, for example, an apparatus of a UE (such as a wireless device 202 that is a UE, as described herein) or a network system (e.g., including multiple network devices 218 such as IAB devices, as described herein).

Embodiments contemplated herein include one or more non-transitory computer-readable media comprising instructions to cause an electronic device, upon execution of the instructions by one or more processors of the electronic device, to perform one or more elements of the method for group handover according to the present disclosure. This non-transitory computer-readable media may be, for example, a memory of a UE (such as a wireless device 202 that is a UE, as described herein) or a network system (e.g., including multiple network devices 218 such as IAB devices, as described herein).

Embodiments contemplated herein include an apparatus comprising logic, modules, or circuitry to perform one or more elements of the method for group handover according to the present disclosure. This apparatus may be, for example, an apparatus of a UE (such as a wireless device 202 that is a UE, as described herein) or a network system (e.g., including multiple network devices 218 such as IAB devices, as described herein).

Embodiments contemplated herein include an apparatus comprising: one or more processors and one or more computer-readable media comprising instructions that, when executed by the one or more processors, cause the one or more processors to perform one or more elements of the method for group handover according to the present disclosure. This apparatus may be, for example, an apparatus of a UE (such as a wireless device 202 that is a UE, as described herein) or a network system (e.g., including multiple network devices 218 such as IAB node, as described herein).

Embodiments contemplated herein include a signal as described in or related to one or more elements of the method for group handover according to the present disclosure.

Embodiments contemplated herein include a computer program or computer program product comprising instructions, wherein execution of the program by a processor is to cause the processor to carry out one or more elements of the method for group handover according to the present disclosure. The processor may be a processor of a UE (such as processor(s) 204 of a wireless device 202 that is a UE, as described herein) or a processor in a network system (such as processor(s) 220 of a network device 218 such as an IAB device, as described herein). These instructions may be, for example, located in the processor and/or on a memory of the UE (such as a memory 206 of a wireless device 202 that is a UE, as described herein) or a memory in a network system (such as a memory 222 of a network device 218 such as an IAB device, as described herein).

### Method for PCI Collision Prevention

Due to mobility of a UE served by a migration IAB node, the PCI of the serving cell for the UE might collide with any of PCIs of one or more neighbor cells for the UE after handover.

In order to avoid a PCI collision during a UE performs handover, there are two optional solutions. In one solution, the UE may be configured to report the observed PCI usage of neighbor cells in a measurement report to the source cell. Another solution happens after the handover, in which the UE may be configured by the initial cell to detect a PCI collision between the serving cell and neighbor cells and report the collision status to the target cell.

### UE Side

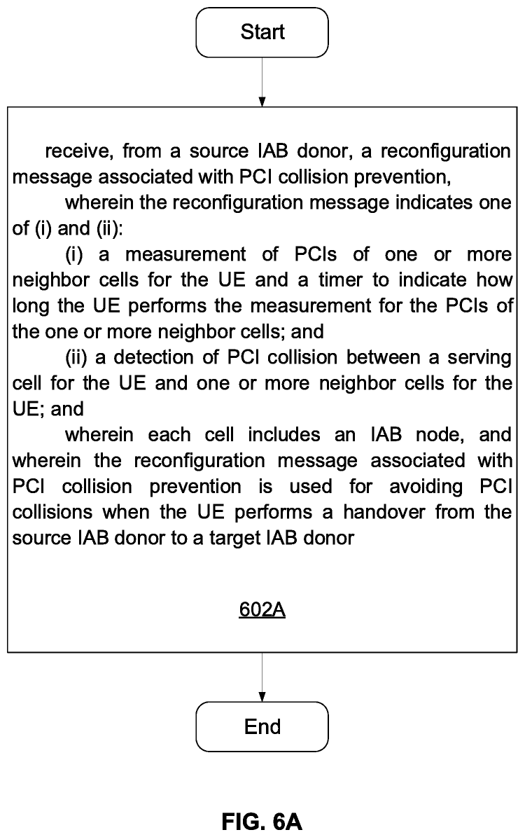

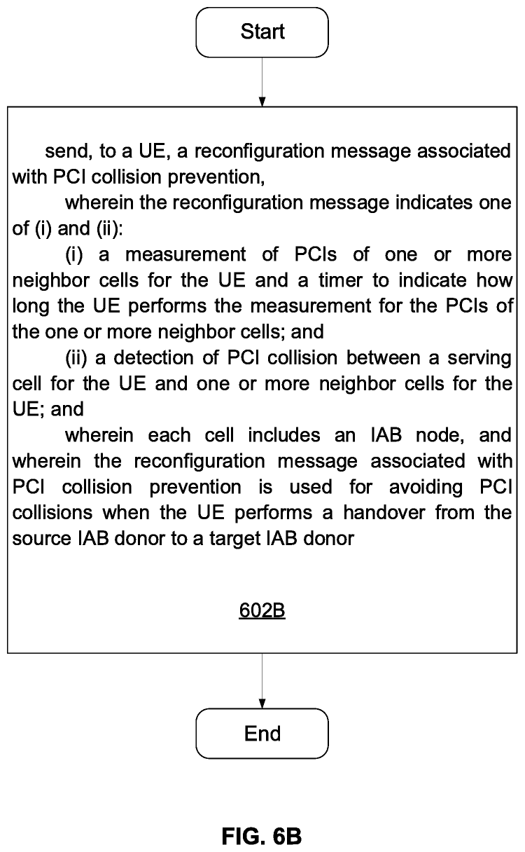

FIG. 6A illustrates a flowchart diagram for an example method at UE side for supporting PCI collision prevention in mobile IAB node scenario. Aspects of the method of FIG. 5A may be implemented by a wireless device such as a UE 102 or 104 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 6A may operate as follows.

At 602A, the UE may receive, from a source IAB donor, a reconfiguration message associated with PCI collision prevention. The reconfiguration message may indicate one of (i) and (ii): (i) a measurement of PCIs of one or more neighbor cells for the UE a timer to indicate how long the UE performs the measurement for the PCIs of the one or more neighbor cells; and (ii) a detection of PCI collision between a serving cell for the UE and one or more neighbor cells for the UE. In such case, each cell may include an IAB device (e.g., an IAB node), and the reconfiguration message associated with PCI collision prevention may be used for avoiding PCI collisions when the UE performs a handover from the source IAB donor to a target IAB donor.

### Network Side

Corresponding to FIG. 6A, FIG. 6B illustrates a flowchart diagram for an example method at network side for supporting PCI collision prevention in mobile IAB node scenario. Aspects of the method of FIG. 6B may be implemented by a network device such as an IAB device (e.g., a source IAB donor) in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 6B may operate as follows.

At 602B, the source IAB donor may send, to a UE, a reconfiguration message associated with PCI collision prevention. The reconfiguration message may indicate one of (i) and (ii): (i) a measurement of PCIs of one or more neighbor cells for the UE a timer to indicate how long the UE performs the measurement for the PCIs of the one or more neighbor cells; and (ii) a detection of PCI collision between a serving cell for the UE and one or more neighbor cells for the UE. In such case, each cell may include an IAB device (e.g., an IAB node), and the reconfiguration message associated with PCI collision prevention may be used for avoiding PCI collisions when the UE performs a handover from the source IAB donor to a target IAB donor.

It should be understood that the method for supporting PCI collision prevention is applicable for situations regarding UE group handover, it is also application for a single UE handover from a source cell to a target cell. In addition, the network device in this method is not necessarily limited to an IAB device, it may be other types of base stations (e.g., eNBs or gNBs) in cells, each of which is associated with a PCI.

It should be appreciated that the reconfiguration message associated with PCI collision prevention may be transmitted and received via RRC layer.

Embodiments contemplated herein include an apparatus comprising means to perform one or more elements of the method for PCI collision prevention according to the present disclosure. This apparatus may be, for example, an apparatus of a UE (such as a wireless device 202 that is a UE, as described herein) or a network device (such as a network device 218 like an IAB device, as described herein).

Embodiments contemplated herein include one or more non-transitory computer-readable media comprising instructions to cause an electronic device, upon execution of the instructions by one or more processors of the electronic device, to perform one or more elements of the method for PCI collision prevention according to the present disclosure. This non-transitory computer-readable media may be, for example, a memory of a UE (such as a wireless device 202 that is a UE, as described herein) or a network device (such as a network device 218 like an IAB device, as described herein).

Embodiments contemplated herein include an apparatus comprising logic, modules, or circuitry to perform one or more elements of the method for PCI collision prevention according to the present disclosure. This apparatus may be, for example, an apparatus of a UE (such as a wireless device 202 that is a UE, as described herein) or a network device (such as a network device 218 like an IAB device, as described herein).

Embodiments contemplated herein include an apparatus comprising: one or more processors and one or more computer-readable media comprising instructions that, when executed by the one or more processors, cause the one or more processors to perform one or more elements of the method for PCI collision prevention according to the present disclosure. This apparatus may be, for example, an apparatus of a UE (such as a wireless device 202 that is a UE, as described herein) or a network device (such as a network device 218 like an IAB device, as described herein).

Embodiments contemplated herein include a signal as described in or related to one or more elements of the method for PCI collision prevention according to the present disclosure.

Embodiments contemplated herein include a computer program or computer program product comprising instructions, wherein execution of the program by a processor is to cause the processor to carry out one or more elements of the method for PCI collision prevention according to the present disclosure. The processor may be a processor of a UE (such as processor(s) 204 of a wireless device 202 that is a UE, as described herein) or a processor in a network device (such as a processor 220 of a network device 218 such as an IAB device, as described herein). These instructions may be, for example, located in the processor and/or on a memory of the UE (such as a memory 206 of a wireless device 202 that is a UE, as described herein) or a memory in a network device (such as a memory 222 of a network device 218 such as an IAB device, as described herein).

### Communication Signaling

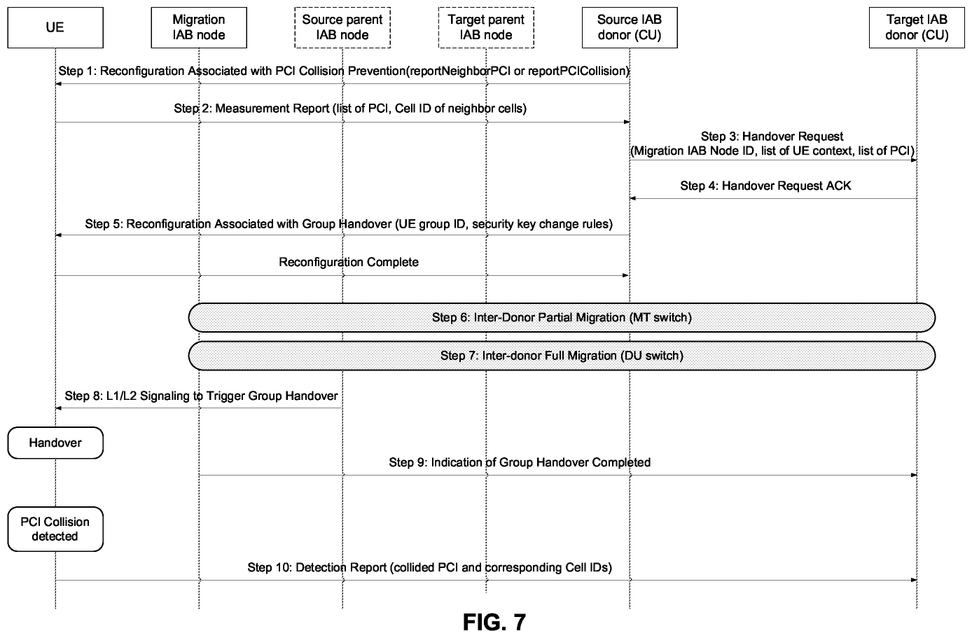

As described above, the method for UE group handover and the method for PCI collision prevention may be performed independently. Alternatively, the two methods may be combined together. FIG. 7 illustrates an example signaling diagram between the UE and network-side devices, according to a combination of two methods. The signaling diagram is not intended to limit the exemplary embodiments in any way. Instead, the signaling diagram provides an example signaling exchange that may be used for supporting UE group handover and PCI collision prevention in mobile IAB scenario. The communication signaling may mainly happen between the UE, the migration IAB node, the source IAB donor and the target IAB donor.

At Step 1, the UE may receive a reconfiguration message associated with PCI collision prevention from the source IAB donor. This reconfiguration message may be transmitted and received via RRC layer, e.g., in the format of RRCReconfiguration message.

According to embodiments of the present disclosure, the reconfiguration message associated with PCI collision prevention may indicate one of the following two configurations: (i) a measurement of PCIs of one or more neighbor cells for the UE (e.g., shown as reportNeighborPCI in FIG. 7); and (ii) a detection of PCI collision between a serving cell for the UE and one or more neighbor cells for the UE (e.g., shown as reportPCICollision in FIG. 7). For example, in the above configuration (i) (e.g., reportNeighborPCI), a timer which may indicate how long the UE should perform the measurement for PCIs of the neighbor cells may be also indicated in the reconfiguration message associated with PCI collision prevention.

Step 2 is directed to the configuration for reportNeighborPCI in Step 1. In response to receiving this configuration, the UE may perform a measurement of PCIs of its available one or more neighbor cells. For example, the UE may start the timer and perform the measurement. Upon expiry of the timer, the UE may stop the measurement and send a measurement report to the source IAB donor. This measurement report may include a list of PCIs, and respective cell identifiers (IDs) and frequencies of the one or more neighbor cells.

At Step 3, the source IAB donor may send a handover request to the target IAB donor. This handover request may include an identifier of (the DU of) the migration IAB node, and a list of UE contexts of all UEs served by the migration IAB node. For example, the UE contexts may indicate the status, supported transmission way, and antenna information of UEs, and so on. This step may avoid sending multiple dedicated handover request messages for each UE served by the migration IAB node. Alternatively, a new Xn message may be introduced to send the above non-UE-associated signaling to include huge payload.

In addition, the handover request sent from the source IAB donor to the target IAB donor may further include the list of PCIs and respective cell IDs of the one or more neighbor cells for the UE obtained from Step 2, as well as the PCI and respective cell ID of the serving cell for the UE. If the PCI of the serving cell does not overlap with any of the list of PCIs of the one or more neighbor cells, the target IAB donor may not change the PCI of the serving cell for the UE, which may avoid an interruption of migration, and save time and overhead. However, if the PCI of the serving cell overlaps with any of the list of PCIs of the one or more neighbor cells, the target IAB donor may need to change the PCI of the serving cell for the UE to a new PCI which does not overlap with any of the list of PCIs of the one or more neighbor cells, after the migration.

At Step 4, the target IAB donor may send an acknowledgement (ACK) for the handover request to the source IAB donor.

At Step 5, the UE may receive a reconfiguration message associated with group handover from the source IAB donor. This reconfiguration message may be transmitted and received via RRC layer, e.g., in the format of RRCReconfiguration message. In order to make UE group handover more flexible, all UEs served by the migration IAB node may be divided into one or more groups, where any two UE groups do not overlap. Accordingly, the source IAB donor may configure multiple UE groups for group handover via dedicated RRCReconfiguration messages.

The specific format of the reconfiguration message associated with group handover may depend on the particular transmission layer of signaling of the triggering message for group handover, which may be Layer 1 (L1) signaling or Layer 2 (L2) signaling.

As for L1 signaling triggering, the reconfiguration message associated with group handover may at least indicate an identifier of a UE group which the receiving UE served by the migration IAB node in Step 5 belongs to, and multiple security key change rules. As an example, the identifier of the UE group may be defined as a function of identifiers (e.g., Cell-Radio Network Temporary Identities (C-RNTIs)) of existing UEs in that UE group. The security key change rules may include following four options (sometimes may only include two options in the middle):
0—no change of security key after group handover;
1—horizontal security key change after group handover;
2—vertical security key change after group handover; and
3—releasing from the migration IAB node which serves the UE group (where the UE may enter IDLE state and perform cell selection).
   In addition, the reconfiguration message may also indicate a Next Chain Count (NCC), which may be used when the security key change rule is determined as vertical security key change during the group handover (thus at this step, the UE may just store this NCC but does not apply it upon receiving NCC).

As for L2 signaling triggering, the reconfiguration message associated with group handover may at least indicate an identifier of a UE group which the receiving UE served by the migration IAB node in Step 5 belongs to, and multiple security key change rules. In addition, the reconfiguration message may also indicate an NCC. Further, the reconfiguration message may include a UE group common RNTI, which may be used for information scrambling.

The handover for the migration IAB node and its served UEs may be performed after the reconfiguration associated with group handover is completed.

It should be understood that the reconfiguration message associated with group handover may be transmitted via Group common G-RNTI scheduling to all UEs in a UE group. The G-RNTI for the transmission of the reconfiguration message may be preconfigured to all UEs in the UE group via a UE-dedicated signaling or derived based on C-RNTIs associated with those UEs.

At Step 6, the MT of the migration IAB node may perform inter-donor switch from (the CU of) the source IAB donor to the (the CU of) target IAB donor. At Step 7, the DU of the migration IAB node may perform inter-donor switch from (the CU of) the source IAB donor to (the CU of) the target IAB donor.

At Step 8, the UE may receive a triggering message for group handover. This triggering message may indicate the above-mentioned identifier of the UE group which the receiving UE served by the migration IAB node belongs to, and a determined security key change rule corresponding to this UE group.

The triggering message for group handover may be transmitted and received via DCI in L1 signaling, or via MAC CE in L2 signaling.

As for L1 signaling, the UE may adopt parameters in the reconfiguration message associated with group handover regarding L1 signaling. For example, the signaling format may be illustrated as TABLE 1 (assuming there are M UE groups).

TABLE 1

| | | | |
|---|---|---|---|
| Group 0 (2 bits) | Group 1 (2 bits) | . . . | Group M (2 bits) |

The determined security key change rule for each UE group could be represented by 2 bits, where “00” refers to the above-described option 0—no change; “01” refers to the option 1—horizontal key change; “10” refers to the option 2—vertical key change; and “11” refers to the option 3—release. Alternatively, the determined security key change rule for each UE group could be represented by 1 bit, where “0” refers to the option 1—horizontal key change; and “1” refers to the option 2—vertical key change.

As for L2 signaling, the UE may adopt parameters in the reconfiguration message associated with group handover regarding L2 signaling. For example, the signaling format may be illustrated as TABLE 2 (assuming there are M groups).

TABLE 2

| | | | |
|---|---|---|---|
| C0 | C1 | . . . | CM |

In the format in TABLE 2, Ci means the RRC configured field of security key change rule for UE group i (i=0, 1, . . . , M). Similar to L1 signaling, the determined security key change rule for each UE group could be represented by 2 bits or 1 bit.

It should be understood that either in L1 signaling or in L2 signaling, the triggering message may only indicate the identifier and corresponding security key change rule for the UE group including the receiving UE, or the triggering message may indicate information for multiple UE groups including said UE group.

After Step 8, the UE performs a group handover from the source IAB donor to the target IAB donor based on the determined security key change rule, which may occur together with other UE(s) in the same UE group. For example, if the security key change rule filed indicates 1 (“01”), the UE may apply horizontal key change. If the security key change rule filed indicates 2 (“10”), the UE may adopt configured NCC in the reconfiguration message associated with group handover and apply vertical key change. If the security key change rule filed indicates 3 (“11”), the UE may release from the serving cell and may enter IDLE state and perform cell selection.

At Step 9, the migration IAB node may notify the target IAB donor that the group handover is completed after UE(s) in a UE group complete handover. As an example, a new Information Element (IE) indicating of group handover completed may be added in a GNB-DU CONFIGURATION UPDATE message sent from the migration IAB node to the target IAB donor.

In practice, the migration IAB node may send the indication message with a time gap, after sending L1/L2 signaling to trigger group handover. This indication message may be transmitted via an Xn message. Alternatively, this indication message may also use BAP control Protocol Data Unit (PDU).

Step 10 is directed to the configuration for reportPCICollision in Step 1. In response to receiving this configuration, the UE may detect whether there is a PCI collision between the serving cell for the UE and the one or more neighbor cells for the UE. If the UE has detected there is a PCI collision between the serving cell for the UE and one or more neighbor cells for the UE, the UE may report a collided PCI and respective cell identifiers associated with the collided PCI (e.g., IDs of cells that are using the same PCI in close range) to the target IAB donor. It should be appreciated that this procedure happens after the UE performs handover. As an example, after completing the group handover, the UE may read system information block 1 (SIB1) of its neighbor cells to determine their NR Cell Global Identifiers (NCGIs) to determine whether there is a PCI collision between the neighbor cells and the serving cell.

It should be understood that one or more source parent IAB nodes and one or more target parent IAB nodes may involve the above communications as relay IAB nodes. Alternatively, there may exist no parent IAB nodes.

Those skilled in the art may appreciate that the steps regarding the migration IAB node may mainly be conducted by the DU of the migration IAB node except for Step 6 in FIG. 7. The steps performed by the source IAB donor and the target IAB donor may mainly be conducted by the CU of the source IAB donor and the CU of the target IAB donor, respectively, in FIG. 7.

It should be appreciated that although steps are depicted in a specific order in the FIG. 7, this should not be understood as requiring such steps to be performed in the specific order shown or in a sequential order, or requiring performing all illustrated steps to achieve a desired result. As an example, Step 5 is not required to be performed right before Step 8, and it may be performed in advance, e.g., before Step 1 as part of an earlier reconfiguration. As another example, Step 2 and Step 10 are not required to be both performed, and the performance of one of them may lead to the effect of PCI collision prevention.

In summary, the Steps 3-4, 5, 6-8, and 9 in FIG. 7 are mainly related to the method for UE group handover, and Steps 1, 2, 3-4, and 10 in FIG. 7 are mainly related to the method for PCI collision prevention. Therefore, the details in these steps may also apply to the corresponding method when performed independently (e.g., in FIG. 5 or FIG. 6).

According to the methods for group handover and PCI collision prevention in mobile IAB scenario proposed in the present disclosure, huge payload for multiple handover request may be avoided, and RACH collisions and PCI collisions may be prevented, thereby increasing the flexibility and efficiency of the communications in the IAB network.

In the following further exemplary embodiments are provided.
(1) A user equipment (UE), comprising:
at least one antenna;
at least one radio coupled to the at least one antenna; and
one or more processors coupled to the at least one radio;
wherein the one or more processors are configured to cause the UE to:
   receive, from a source Integrated Access and Backhaul (IAB) donor, a reconfiguration message associated with group handover, the reconfiguration message indicating an identifier of a UE group including one or more UEs served by a migration IAB node and multiple security key change rules, wherein said UE belongs to the UE group, and wherein the migration IAB node performs an inter-donor switch from the source IAB donor to a target IAB donor and serves said UE;
   receive, from the migration IAB node, a triggering message for group handover, the triggering message indicating said identifier of the UE group and a determined security key change rule corresponding to the UE group, wherein the determined security key change rule is included in the multiple security key change rules; and
   in response to receiving the triggering message, perform a group handover from the source IAB donor to the target IAB donor, based on the determined security key change rule corresponding to the UE group.
(2) The UE of (1), wherein a handover request sent from the source IAB donor to the target IAB donor includes at least an identifier of the migration IAB node and UE contexts of all UEs served by the migration IAB node.
(3) The UE of (1), wherein:
the reconfiguration message associated with group handover is received via Radio Resource Control (RRC) layer, wherein the identifier of the UE group is a function of identifiers of the one or more UEs in the UE group; and
the triggering message for group handover is received via Downlink Control Information (DCI) in Layer 1 (L1).
(4) The UE of (1), wherein:
the reconfiguration message associated with group handover is received via Radio Resource Control (RRC) layer, the reconfiguration message further indicating a UE group common Radio Network Temporary Identity (RNTI); and the triggering message for group handover is received via Media Access Control (MAC) Control Element (CE) in Layer 2 (L2).
(5) The UE of (1), wherein:
the reconfiguration message associated with group handover is transmitted via Group common Radio Network Temporary Identity (G-RNTI) scheduling to the one or more UEs in the UE group.
(6) The UE of (5), wherein:
the G-RNTI for the transmission of the reconfiguration message is preconfigured to the one or more UEs in the UE group via a UE-dedicated signaling or derived based on Cell Radio Network Temporary Identity (C-RNTI) associated with the one or more UEs.
(7) The UE of (1), wherein the determined security key change rule corresponding to the UE group includes one of the following:
no change of security key after group handover;
horizontal security key change after group handover;
vertical security key change after group handover; and
releasing from the migration IAB node which serves the UE group.
(8) The UE of (1), wherein:
the reconfiguration message associated with group handover further indicates a Next Chain Count (NCC), which is used when the security key change rule is vertical security key change after group handover.
(9) The UE of (1), wherein:
after the UE performs the group handover, the migration IAB node notifies the target IAB donor that the group handover is completed via an Xn message or a Backhaul Adaptation Protocol (BAP) control Protocol Data Unit (PDU).
(10) The UE of (1), wherein:
the source IAB donor includes at least a central unit (CU), and the target IAB donor includes at least a central unit (CU); and
the CU of the source IAB donor is different from the CU of the target IAB donor.
(11) The UE of (10), wherein:
the migration IAB node includes a mobile terminal (MT) and a distributed unit (DU); and
the migration IAB node performing an inter-donor switch from the source IAB donor to the target IAB donor includes: the MT of the migration IAB node performing an inter-donor switch from the CU of the source IAB donor to the CU of the target IAB donor, and the DU of the migration IAB node performing an inter-donor switch from the CU of the source IAB donor to the CU of the target IAB donor.
(12) The UE of (1), wherein the UE and the migration IAB node are movable.
(13) The UE of (1), wherein the one or more processors are further configured to cause the UE to:
receive, from the source IAB donor, a reconfiguration message associated with Physical Cell Identifier (PCI) collision prevention.
(14) The UE of (13), wherein the reconfiguration message associated with PCI collision prevention indicates one of (i) and (ii):
(i) a measurement of PCIs of one or more neighbor cells for the UE and a timer to indicate how long the UE performs the measurement for the PCIs of the one or more neighbor cells; and
(ii) a detection of PCI collision between a serving cell for the UE and one or more neighbor cells for the UE, wherein each cell includes an IAB node.
(15) The UE of (14), wherein the one or more processors are further configured to cause the UE to:
in response to receiving the reconfiguration message associated with PCI collision prevention indicating a measurement of PCIs of one or more neighbor cells for the UE and a timer, start the time, and perform a measurement of PCIs of the one or more neighbor cells; and report, to the source IAB donor, a list of PCIs, and respective cell identifiers and frequencies of the one or more neighbor cells for the UE, when the time expires.
(16) The UE of (15), wherein:
a handover request sent from the source IAB donor to the target IAB donor includes at least the list of PCIs and respective cell identifiers of the one or more neighbor cells for the UE and the PCI and respective cell identifier of the serving cell for the UE; and
in response to the PCI of the serving cell not overlapping with any of the list of PCIs of the one or more neighbor cells, the target IAB donor does not change the PCI of the serving cell for the UE; or in response to the PCI of the serving cell overlapping with any of the list of PCIs of the one or more neighbor cells, the target IAB donor changes the PCI of the serving cell for the UE to a new PCI which does not overlap with any of the list of PCIs of the one or more neighbor cells.
(17) The UE of (14), wherein the one or more processors are further configured to cause the UE to:
in response to receiving the reconfiguration message associated with PCI collision prevention indicating a detection of PCI collision between the serving cell for the UE and one or more neighbor cells for the UE, detect whether there is a PCI collision between the serving cell for the UE and the one or more neighbor cells for the UE, after performing the group handover from the source IAB donor to the target IAB donor; and
in response to detecting there is a PCI collision between the serving cell for the UE and the one or more neighbor cells for the UE, report, to the target IAB donor, a collided PCI, and respective cell identifiers associated with the collided PCI.
(18) A user equipment (UE), comprising:
at least one antenna;
at least one radio coupled to the at least one antenna; and
one or more processors coupled to the at least one radio;
wherein the one or more processors are configured to cause the UE to:
   receive, from a source Integrated Access and Backhaul (IAB) donor, a reconfiguration message associated with Physical Cell Identifier (PCI) collision prevention,
   wherein the reconfiguration message indicates one of (i) and (ii):
   (i) a measurement of PCIs of one or more neighbor cells for the UE and a timer to indicate how long the UE performs the measurement for the PCIs of the one or more neighbor cells, and
   (ii) a detection of PCI collision between a serving cell for the UE and one or more neighbor cells for the UE; and
   wherein each cell includes an IAB node, and wherein the reconfiguration message associated with PCI collision prevention is used for avoiding PCI collisions when the UE performs a handover from the source IAB donor to a target IAB donor.
(19) The UE of (18), wherein the one or more processors are further configured to cause the UE to:
in response to receiving the reconfiguration message associated with PCI collision prevention indicating a measurement of PCIs of one or more neighbor cells for the UE and a timer, start the time and perform a measurement of PCIs of the one or more neighbor cells; and report, to the source IAB donor, a list of PCIs, and respective cell identifiers and frequencies of the one or more neighbor cells for the UE, when the timer expires.
(20) The UE of (19), wherein:
a handover request sent from the source IAB donor to the target IAB donor includes at least the list of PCIs and respective cell identifiers of the one or more neighbor cells for the UE and the PCI and respective cell identifier of the serving cell for the UE; and
in response to the PCI of the serving cell not overlapping with any of the list of PCIs of the one or more neighbor cells, the target IAB donor does not change the PCI of the serving cell for the UE; or in response to the PCI of the serving cell overlapping with any of the list of PCIs of the one or more neighbor cells, the target IAB donor changes the PCI of the serving cell for the UE to a new PCI which does not overlap with any of the list of PCIs of the one or more neighbor cells.
(21) The UE of (18), wherein the one or more processors are further configured to cause the UE to:
in response to receiving the reconfiguration message associated with PCI collision prevention indicating a detection of PCI collision between the serving cell for the UE and one or more neighbor cells for the UE, detect whether there is a PCI collision between the serving cell for the UE and the one or more neighbor cells for the UE, after performing the handover from the source IAB donor to the target IAB donor; and
in response to detecting there is a PCI collision between the serving cell for the UE and the one or more neighbor cells for the UE, report, to the target IAB donor, a collided PCI, and respective cell identifiers associated with the collided PCI.
(22) A network system, including a source Integrated Access and Backhaul (IAB) donor, a target IAB donor, and a migration IAB node which performs an inter-donor switch from the source IAB donor to the target IAB donor, the network system being configured to:
send, from the source IAB donor to a user equipment (UE) served by the migration IAB node, a reconfiguration message associated with group handover, the reconfiguration message indicating an identifier of a UE group including one or more UEs served by a migration IAB node and multiple security key change rules, wherein said UE belongs to the UE group; and
send, from the migration IAB node to the UE, a triggering message for group handover, the triggering message indicating said identifier of the UE group and a determined security key change rule corresponding to the UE group, wherein the determined security key change rule is included in the multiple security key change rules;
wherein the triggering message causes the UE to perform a group handover from the source IAB donor to the target IAB donor, based on the determined security key change rule corresponding to the UE group.
(23) A network device including a source Integrated Access and Backhaul (IAB) donor, comprising:
at least one antenna;
at least one radio coupled to the at least one antenna; and
one or more processors coupled to the at least one radio;
wherein the one or more processors are configured to cause the source IAB donor to:
   send, to a user equipment (UE), a reconfiguration message associated with Physical Cell Identifier (PCI) collision prevention,
   wherein the reconfiguration message indicates one of (i) and (ii):
   (i) a measurement of PCIs of one or more neighbor cells for the UE and a timer to indicate how long the UE performs the measurement for the PCIs of the one or more neighbor cells; and
   (ii) a detection of PCI collision between a serving cell for the UE and one or more neighbor cells for the UE; and
   wherein each cell includes an IAB node, and wherein the reconfiguration message associated with PCI collision prevention is used for avoiding PCI collisions when the UE performs a handover from the source IAB donor to a target IAB donor.
(24) A method for a user equipment (UE), comprising:
receiving, from a source Integrated Access and Backhaul (IAB) donor, a reconfiguration message associated with group handover, the reconfiguration message indicating an identifier of a UE group including one or more UEs served by a migration IAB node and multiple security key change rules, wherein said UE belongs to the UE group, and wherein the migration IAB node performs an inter-donor switch from the source IAB donor to a target IAB donor and serves said UE;
receiving, from the migration IAB node, a triggering message for group handover, the triggering message indicating said identifier of the UE group and a determined security key change rule corresponding to the UE group, wherein the determined security key change rule is included in the multiple security key change rules; and
in response to receiving the triggering message, performing a group handover from the source IAB donor to the target IAB donor, based on the determined security key change rule corresponding to the UE group.
(25) A method for a user equipment (UE), comprising:
receiving, from a source Integrated Access and Backhaul (IAB) donor, a reconfiguration message associated with Physical Cell Identifier (PCI) collision prevention, wherein the reconfiguration message indicates one of (i) and (ii):
(i) a measurement of PCIs of one or more neighbor cells for the UE and a timer to indicate how long the UE performs the measurement for the PCIs of the one or more neighbor cells; and
(ii) a detection of PCI collision between a serving cell for the UE and one or more neighbor cells for the UE; and
wherein each cell includes an IAB node, and wherein the reconfiguration message associated with PCI collision prevention is used for avoiding PCI collisions when the UE performs a handover from the source IAB donor to a target IAB donor.
(26) A method for a network system, the network system including a source Integrated Access and Backhaul (IAB) donor, a target IAB donor, and a migration IAB node which performs an inter-donor switch from the source IAB donor to the target IAB donor, the method comprising:
sending, from the source IAB donor to a user equipment (UE) served by the migration IAB node, a reconfiguration message associated with group handover, the reconfiguration message indicating an identifier of a UE group including one or more UEs served by a migration IAB node and multiple security key change rules, wherein said UE belongs to the UE group; and
sending, from the migration IAB node to the UE, a triggering message for group handover, the triggering message indicating said identifier of the UE group and a determined security key change rule corresponding to the UE group, wherein the determined security key change rule is included in the multiple security key change rules;
wherein the triggering message causes the UE to perform a group handover from the source IAB donor to the target IAB donor, based on the determined security key change rule corresponding to the UE group.
(27) A method for a network device including a source Integrated Access and Backhaul (IAB) donor, the method comprising:
sending, to a user equipment (UE), a reconfiguration message associated with Physical Cell Identifier (PCI) collision prevention,
wherein the reconfiguration message indicates one of (i) and (ii):
(i) a measurement of PCIs of one or more neighbor cells for the UE and a timer to indicate how long the UE performs the measurement for the PCIs of the one or more neighbor cells; and
(ii) a detection of PCI collision between a serving cell for the UE and one or more neighbor cells for the UE; and
wherein each cell includes an IAB node, and wherein the reconfiguration message associated with PCI collision prevention is used for avoiding PCI collisions when the UE performs a handover from the source IAB donor to a target IAB donor.
(28) An apparatus for operating a user equipment (UE), the apparatus comprising:
a processor configured to cause the UE to:
   receive, from a source Integrated Access and Backhaul (IAB) donor, a reconfiguration message associated with group handover, the reconfiguration message indicating an identifier of a UE group including one or more UEs served by a migration IAB node and multiple security key change rules, wherein said UE belongs to the UE group, and wherein the migration IAB node performs an inter-donor switch from the source IAB donor to a target IAB donor and serves said UE;
   receive, from the migration IAB node, a triggering message for group handover, the triggering message indicating said identifier of the UE group and a determined security key change rule corresponding to the UE group, wherein the determined security key change rule is included in the multiple security key change rules; and
   in response to receiving the triggering message, perform a group handover from the source IAB donor to the target IAB donor, based on the determined security key change rule corresponding to the UE group.
(29) An apparatus for operating a user equipment (UE), the apparatus comprising:
a processor configured to cause the UE to:
   receive, from a source Integrated Access and Backhaul (IAB) donor, a reconfiguration message associated with Physical Cell Identifier (PCI) collision prevention,
   wherein the reconfiguration message indicates one of (i) and (ii):
   (i) a measurement of PCIs of one or more neighbor cells for the UE and a timer to indicate how long the UE performs the measurement for the PCIs of the one or more neighbor cells; and
   (ii) a detection of PCI collision between a serving cell for the UE and one or more neighbor cells for the UE; and
   wherein each cell includes an IAB node, and wherein the reconfiguration message associated with PCI collision prevention is used for avoiding PCI collisions when the UE performs a handover from the source IAB donor to a target IAB donor.
(30) A non-transitory computer-readable storage medium storing instructions, where the instructions, when executed by a computer system, cause the computer system to perform the method of (24) or (25).
(31) A non-transitory computer-readable storage medium storing instructions, where the instructions, when executed by a computer system, cause the computer system to perform the method of (26) or (27).
(32) A computer program product, comprising program instructions which, when executed by a computer system, cause the computer system to perform the method of (24) or (25).
(33) A computer program product, comprising program instructions which, when executed by a computer system, cause the computer system to perform the method of (26) or (27).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
one or more processors coupled to the at least one radio;
wherein the one or more processors are configured to cause the UE to:
receive, from a source Integrated Access and Backhaul (IAB) donor, a reconfiguration message associated with group handover, the reconfiguration message indicating an identifier of a UE group including one or more UEs served by a migration IAB node and multiple security key change rules, wherein said UE belongs to the UE group, and wherein the migration IAB node performs an inter-donor switch from the source IAB donor to a target IAB donor and serves said UE;
receive, from the migration IAB node, a triggering message for group handover, the triggering message indicating said identifier of the UE group and a determined security key change rule corresponding to the UE group, wherein the determined security key change rule is included in the multiple security key change rules; and
in response to receiving the triggering message, perform a group handover from the source IAB donor to the target IAB donor, based on the determined security key change rule corresponding to the UE group.

2. The UE of claim 1, wherein a handover request sent from the source IAB donor to the target IAB donor includes at least an identifier of the migration IAB node and UE contexts of all UEs served by the migration IAB node.

3. The UE of claim 1, wherein:
the reconfiguration message associated with group handover is received via Radio Resource Control (RRC) layer, wherein the identifier of the UE group is a function of identifiers of the one or more UEs in the UE group; and
the triggering message for group handover is received via Downlink Control Information (DCI) in Layer 1 (L1).

4. The UE of claim 1, wherein:
the reconfiguration message associated with group handover is received via Radio Resource Control (RRC) layer, the reconfiguration message further indicating a UE group common Radio Network Temporary Identity (RNTI); and
the triggering message for group handover is received via Media Access Control (MAC) Control Element (CE) in Layer 2 (L2).

5. The UE of claim 1, wherein:
the reconfiguration message associated with group handover is transmitted via Group common Radio Network Temporary Identity (G-RNTI) scheduling to the one or more UEs in the UE group.

6. The UE of claim 5, wherein:
the G-RNTI for the transmission of the reconfiguration message is preconfigured to the one or more UEs in the UE group via a UE-dedicated signaling or derived based on Cell Radio Network Temporary Identity (C-RNTI) associated with the one or more UEs.

7. The UE of claim 1, wherein the determined security key change rule corresponding to the UE group includes one of the following:
no change of security key after group handover;
horizontal security key change after group handover;
vertical security key change after group handover; and
releasing from the migration IAB node which serves the UE group.

8. The UE of claim 1, wherein:
the reconfiguration message associated with group handover further indicates a Next Chain Count (NCC), which is used when the security key change rule is vertical security key change after group handover.

9. The UE of claim 1, wherein:
after the UE performs the group handover, the migration IAB node notifies the target IAB donor that the group handover is completed via an Xn message or a Backhaul Adaptation Protocol (BAP) control Protocol Data Unit (PDU).

10. The UE of claim 1, wherein:
the source IAB donor includes at least a central unit (CU), and the target IAB donor includes at least a central unit (CU); and
the CU of the source IAB donor is different from the CU of the target IAB donor.

11. The UE of claim 10, wherein:
the migration IAB node includes a mobile terminal (MT) and a distributed unit (DU); and
the migration IAB node performing an inter-donor switch from the source IAB donor to the target IAB donor includes: the MT of the migration IAB node performing an inter-donor switch from the CU of the source IAB donor to the CU of the target IAB donor, and the DU of the migration IAB node performing an inter-donor switch from the CU of the source IAB donor to the CU of the target IAB donor.

12. The UE of claim 1, wherein the UE and the migration IAB node are movable.

13. The UE of claim 1, wherein the one or more processors are further configured to cause the UE to:
receive, from the source IAB donor, a reconfiguration message associated with Physical Cell Identifier (PCI) collision prevention.

14. The UE of claim 13, wherein the reconfiguration message associated with PCI collision prevention indicates one of (i) and (ii):
(i) a measurement of PCIs of one or more neighbor cells for the UE and a timer to indicate how long the UE performs the measurement for the PCIs of the one or more neighbor cells; and
(ii) a detection of PCI collision between a serving cell for the UE and one or more neighbor cells for the UE,
wherein each cell includes an IAB node.

15. The UE of claim 14, wherein the one or more processors are further configured to cause the UE to:
in response to receiving the reconfiguration message associated with PCI collision prevention indicating a measurement of PCIs of one or more neighbor cells for the UE and a timer, start the time, and perform a measurement of PCIs of the one or more neighbor cells; and
report, to the source IAB donor, a list of PCIs, and respective cell identifiers and frequencies of the one or more neighbor cells for the UE, when the time expires.

16. The UE of claim 15, wherein:
a handover request sent from the source IAB donor to the target IAB donor includes at least the list of PCIs and respective cell identifiers of the one or more neighbor cells for the UE and the PCI and respective cell identifier of the serving cell for the UE; and
in response to the PCI of the serving cell not overlapping with any of the list of PCIs of the one or more neighbor cells, the target IAB donor does not change the PCI of the serving cell for the UE; or in response to the PCI of the serving cell overlapping with any of the list of PCIs of the one or more neighbor cells, the target IAB donor changes the PCI of the serving cell for the UE to a new PCI which does not overlap with any of the list of PCIs of the one or more neighbor cells.

17. The UE of claim 14, wherein the one or more processors are further configured to cause the UE to:
in response to receiving the reconfiguration message associated with PCI collision prevention indicating a detection of PCI collision between the serving cell for the UE and one or more neighbor cells for the UE, detect whether there is a PCI collision between the serving cell for the UE and the one or more neighbor cells for the UE, after performing the group handover from the source IAB donor to the target IAB donor; and
in response to detecting there is a PCI collision between the serving cell for the UE and the one or more neighbor cells for the UE, report, to the target IAB donor, a collided PCI, and respective cell identifiers associated with the collided PCI.

18. A user equipment (UE), comprising:
at least one antenna;
at least one radio coupled to the at least one antenna; and
one or more processors coupled to the at least one radio;
wherein the one or more processors are configured to cause the UE to:
receive, from a source Integrated Access and Backhaul (IAB) donor, a reconfiguration message associated with Physical Cell Identifier (PCI) collision prevention,
wherein the reconfiguration message indicates one of (i) and (ii):
(i) a measurement of PCIs of one or more neighbor cells for the UE and a timer to indicate how long the UE performs the measurement for the PCIs of the one or more neighbor cells, and
(ii) a detection of PCI collision between a serving cell for the UE and one or more neighbor cells for the UE; and
wherein each cell includes an IAB node, and wherein the reconfiguration message associated with PCI collision prevention is used for avoiding PCI collisions when the UE performs a handover from the source IAB donor to a target IAB donor.

19. The UE of claim 18, wherein the one or more processors are further configured to cause the UE to:
in response to receiving the reconfiguration message associated with PCI collision prevention indicating a measurement of PCIs of one or more neighbor cells for the UE and a timer, start the time and perform a measurement of PCIs of the one or more neighbor cells; and
report, to the source IAB donor, a list of PCIs, and respective cell identifiers and frequencies of the one or more neighbor cells for the UE, when the timer expires.

20. The UE of claim 19, wherein:
a handover request sent from the source IAB donor to the target IAB donor includes at least the list of PCIs and respective cell identifiers of the one or more neighbor cells for the UE and the PCI and respective cell identifier of the serving cell for the UE; and
in response to the PCI of the serving cell not overlapping with any of the list of PCIs of the one or more neighbor cells, the target IAB donor does not change the PCI of the serving cell for the UE; or in response to the PCI of the serving cell overlapping with any of the list of PCIs of the one or more neighbor cells, the target IAB donor changes the PCI of the serving cell for the UE to a new PCI which does not overlap with any of the list of PCIs of the one or more neighbor cells.

21-33. (canceled)
